(19) United States
(12) Patent Application Publication
(10) Pub. No.: US 2016/0059577 A1
(43) Pub. Date: Mar. 3, 2016

(54) IMAGE PROCESSING APPARATUS AND IMAGE PROCESSING METHOD

(71) Applicant: Hironobu HORIKOSHI, Kanagawa (JP)

(72) Inventor: Hironobu HORIKOSHI, Kanagawa (JP)

(73) Assignee: Ricoh Company, Ltd., Tokyo (JP)

(21) Appl. No.: 14/840,846

(22) Filed: Aug. 31, 2015

(30) Foreign Application Priority Data
Sep. 2, 2014 (JP) 2014-178571
Aug. 18, 2015 (JP) 2015-161139

(51) Int. Cl. B41J 2/175

(52) U.S. Cl. CPC B41J 2/17566

(57) ABSTRACT

An image processing apparatus includes a status monitor; and a printer driver. The status monitor includes an ink consumption amount data storage unit configured to monitor an ink usage status of a user and store data of a consumption amount of ink of the user, and an ink consumption amount control unit configured to select an ink consumption amount reduction measure for a particular color to equalize the consumption amounts of ink of respective colors based on the stored data of the consumption amount of ink. The printer driver includes a drawing unit configured to perform image processing when a drawing instruction to a printer is received, and send a print instruction to the printer, and a UI unit configured to receive a print setting change.

### BACKGROUND OF THE INVENTION

1. Field of the Invention

The present invention relates to an image processing apparatus and an image processing method.

2. Description of the Related Art

In inkjet printers, there are cases where only a particular color among the four colors of CMYK has a large amount consumed, and the particular color is in a near-end state, or is approaching a near-end state. Therefore, there are cases where the inkjet printer is provided with a mode for printing by suppressing the consumption of the particular color. According to this mode, the inkjet printer is able to consume all colors by average amounts (see, for example, Patent Document 1).

Patent Document 1 discloses a configuration in which, when ink of a particular color has been consumed to a certain extent, the usage amount of the ink of the particular color is suppressed in subsequent printing operations, for the purpose of averaging the consumption of ink of the respective colors.

However, the invention described in Patent Document 1 has a problem in that it is not possible to suppress the imbalance in the colors in the initial printing operation. That is, by the technology of averaging the consumption of ink in the conventional inkjet printer, there is only a measure of suppressing the consumption of a particular color after the ink of the particular color is used excessively in an imbalanced manner and a near-end state of the particular color occurs, etc. Therefore, it is not possible to suppress the imbalance of colors that occurs in the initial printing operation.

Patent Document 1: Japanese Laid-Open Patent Publication No. 2007-007976

### SUMMARY OF THE INVENTION

The present invention provides an image processing apparatus and an image processing method, in which one or more of the above-described disadvantages are eliminated.

According to an aspect of the present invention, there is provided a non-transitory computer-readable recording medium storing a program that causes a computer that constitutes an image processing apparatus to execute a process, the image processing apparatus including an ink consumption amount data storage unit configured to store data of a consumption amount of ink, and an ink consumption amount control unit and a control unit configured to control the consumption amount of ink, the process including monitoring an ink usage status of a user and storing the data of the consumption amount of ink of the user, by the ink consumption amount data storage unit; selecting an ink consumption amount reduction measure for a particular color to equalize the consumption amounts of ink of respective colors based on the stored data of the consumption amount of ink, by the ink consumption amount control unit; and sending information of the ink consumption amount reduction measure for the particular color to a printer driver, and causing a printer to perform printing by ink proportions for equalizing the consumption amounts of ink of the respective colors in subsequent printing operations, by the control unit.

According to an aspect of the present invention, there is provided an image processing apparatus including a status monitor; and a printer driver, wherein the status monitor includes an ink consumption amount data storage unit configured to monitor an ink usage status of a user and store data of a consumption amount of ink of the user, and an ink consumption amount control unit configured to select an ink consumption amount reduction measure for a particular color to equalize the consumption amounts of ink of respective colors based on the stored data of the consumption amount of ink, and wherein the printer driver includes a drawing unit configured to perform image processing when a drawing instruction to a printer is received, and send a print instruction to the printer, and a UI unit configured to receive a print setting change.

According to an aspect of the present invention, there is provided an image processing method including receiving and storing status information including data of an ink usage status of an image processing apparatus; referring to the stored data of the ink usage status, and adjusting a consumption amount of ink when consumption of ink of a color of a small amount needs to be suppressed; giving an instruction to adjust the consumption amount of ink to a drawing unit of a printer driver; and causing a printer to perform printing in a state where the consumption amount of ink is adjusted, when a print instruction is received.

### BRIEF DESCRIPTION OF THE DRAWINGS

Other objects, features and advantages of the present invention will become more apparent from the following detailed description when read in conjunction with the accompanying drawings, in which:

FIG. 1 is a system configuration diagram according to an embodiment;

FIG. 2 is an overall configuration diagram of a general-purpose printer;

FIG. 3 is an example of an overall block diagram of a control unit of an inkjet recording apparatus;

FIG. 4 is an example of a hardware configuration diagram of a PC, a server, and a mobile phone;

FIG. 5 is an example of a hardware configuration diagram of a printer (MFP);

FIG. 6 illustrates a state where the PC and the printer are connected;

FIG. 7 is an example of a functional block diagram inside the PC;

FIG. 8 illustrates an example of a screen UI of the status monitor, as an application for monitoring the status of the printer from the PC;

FIG. 9 illustrates the relationship between the usage period of a certain printer and the consumption amount of ink;

FIG. 10A is a graph of the ink usage amounts within two years;

FIG. 10B is a graph of the ink usage amounts in a case where ink of CMY is used in appropriate ratios as a substitute of the ink of K;

FIG. 11 is an example of a flowchart indicating how to make the setting for reducing the consumption amount with respect to the ink consumption amount data of the printer;

FIG. 12 is an example of a flowchart of processing procedures performed during the data storage period of step S1 in FIG. 11; and

FIG. 13 is an example of a sequence diagram indicating the exchange of data among the printer, the status monitor, and the printer driver.

### DETAILED DESCRIPTION OF THE PREFERRED EMBODIMENTS

A description is given of embodiments of the present invention.

### <Overview>

An embodiment of the present invention has the following features in the process relevant to print settings of an inkjet printer.

In essence, the ink usage status of a user is monitored for a long period of time and the data is stored, and a print setting and an image setting are made to reduce the imbalance in color consumption unique to the user.

A detailed description is given, with reference to the accompanying drawings, of the above feature of the present invention.

### Embodiment

### [System Configuration]

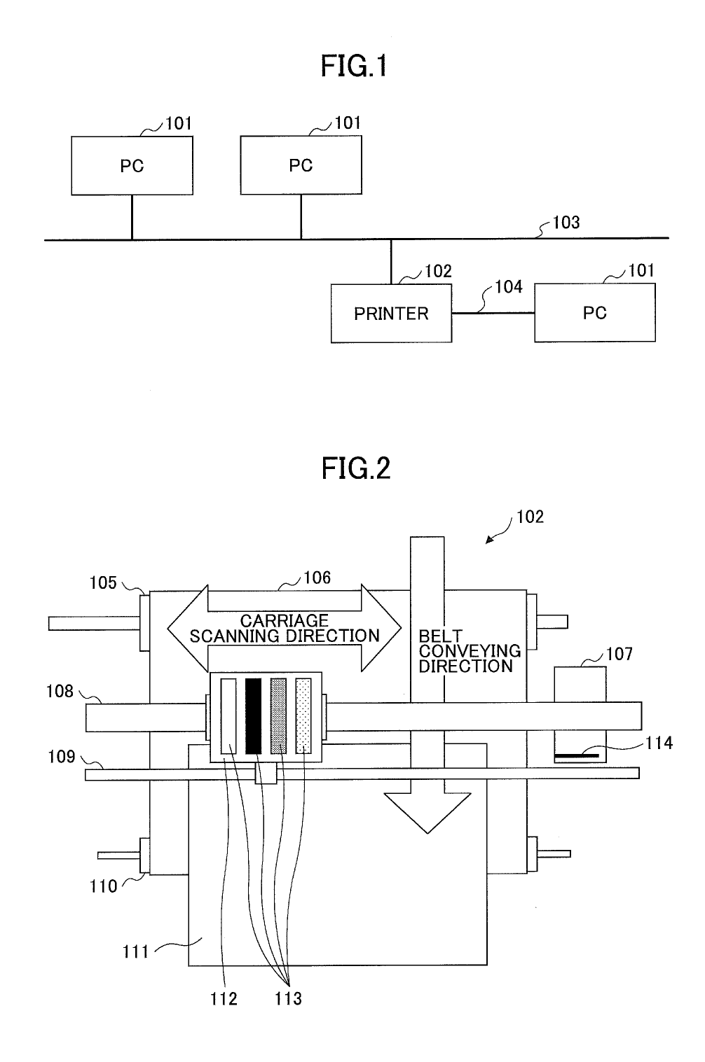

FIG. 1 is a system configuration diagram according to an embodiment.

In this system, a plurality of PCs (Personal Computers) 101 and a printer 102 are communicatively connected to each other via a network 103 or a USB cable 104. The print data that is created or processed at each PC 101 is sent to the printer 102 via the network 103 or the USB cable 104, and is printed.

### [General Printer]

FIG. 2 is an overall configuration diagram of a general-purpose printer.

The printer 102 includes print heads 113 for discharging ink, a carriage 112 provided with the print heads 113, guide rods 108, 109 for supporting the carriage 112, a conveying belt 106 for conveying a recording medium 111, and a conveying roller 105 for driving the conveying belt 106. Note that the print head is also referred to as a recording head.

### [Basic Operations]

The basic operation of the printer 102 includes causing the carriage 112 to perform scanning facing the recording medium 111 along the guide rods 108, 109, and discharging ink from the print heads 113, to record images on the recording medium 111. For every scan by the carriage 112, the conveying belt 106 is driven to convey the recording medium 111, and images are recorded on the entire recording medium 111.

Furthermore, the print heads 113 are respectively connected with ink cartridges by tubes. When the ink inside the print heads 113 is consumed by a printing operation, the ink is supplied from the cartridges to the print heads 113.

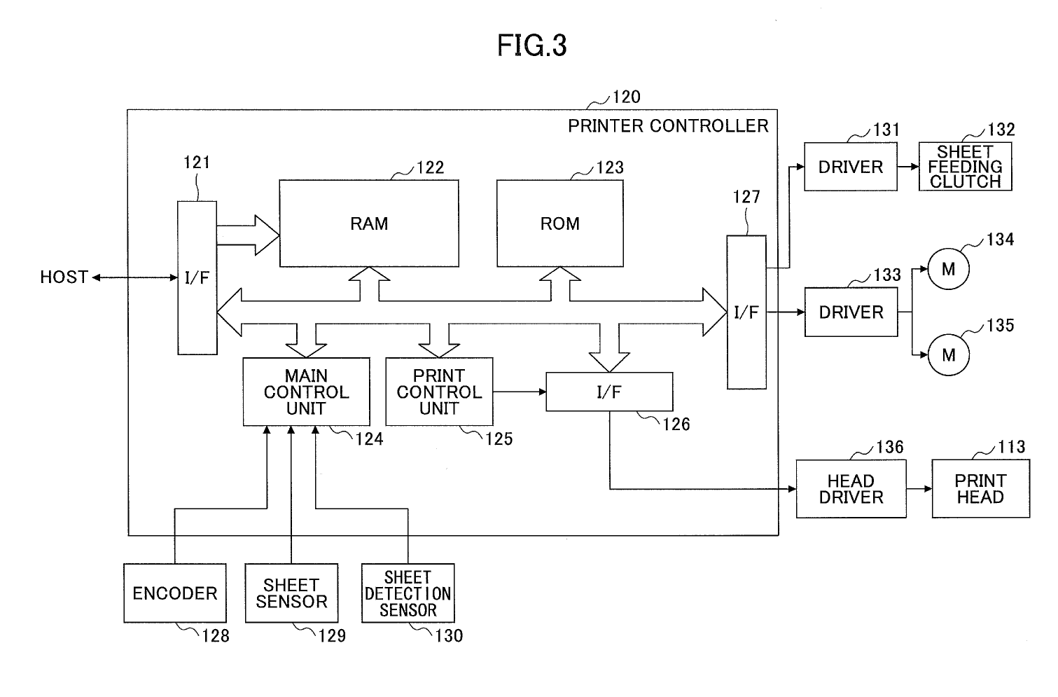

FIG. 3 is an example of an overall block diagram of a control unit of an inkjet recording apparatus.

The control unit includes a printer controller 120, a driver 133 that drives a main scanning motor 134 and a sub scanning motor 135, a driver 131 that drives a sheet feeding clutch 132 for transmitting the rotation of the sub scanning to the sheet feeding roller, and a head driver 136 for driving the print heads 113.

The print heads 113 are also referred to as inkjet heads, and the head driver 136 is constituted by a head driving circuit and a driver IC.

The printer controller 120 includes an interface (hereinafter, “I/F”) 121 that receives print data, etc., from the host side via a cable or a network, a main control unit 124 constituted by a CPU, etc., a RAM 122, a ROM 123, the head driver 136, and I/F 126, 127. Note that the CPU is an abbreviation of Central Processing Unit.

The host side includes an information processing apparatus such as a personal computer, an image reading apparatus such as an image scanner, and an image pickup apparatus including a digital camera.

The I/F 121 is a device that has a function of receiving print data, etc., from the host side via a cable or a network.

The RAM (Random Access Memory) 122 is a device for recording various kinds of data, etc., and is used as various buffers, a work memory, etc.

The ROM (Read Only Memory) 123 is a device storing a routine, etc., for various data processes, and stores various control routines, font data, graphic functions, various procedures, etc., which are executed by the main control unit 124.

The head driver 136 is a drive signal generation circuit for generating drive waveforms for the print heads 113.

The I/F 126 is a device for sending print data, drive waveforms, etc., which have been expanded into dot pattern data (also referred to as bitmap data), to the head driver 136.

The I/F 127 is a device for sending motor drive data to the driver 133, and for sending clutch on signals to the driver 131.

A sheet sensor 129 is a sensor for detecting information mainly for conveying the sheet, such as the width and the length of the sheet.

The sheet detection sensor 130 is a sensor for detecting whether there is a sheet. The sheet sensor 129 and the sheet detection sensor 130 are, for example, a photo interrupter.

The main control unit 124 implements sheet feeding control based on detection signals from the sheet detection sensor 130. Furthermore, the main control unit 124 detects the position of the carriage 112 (see FIG. 2) in the main scanning direction based on output signals from an encoder 128, and implements stop position control on the carriage 112. The main control unit 124 detects the leading edge position of the sheet that is the recording medium 111 and whether there is a sheet on the conveying belt 106 (see FIG. 2), based on detection signals of the sheet sensor 129.

The main control unit 124 reads the print data inside the reception buffers included in the I/F 126, 127, analyzes the print data, stores intermediate code data obtained as the analysis result in a predetermined area in the RAM 122, and outputs an image by using font data stored in the ROM 123 based on the stored analysis result. The main control unit 124 generates dot pattern data for the image output, and stores the dot pattern data in a different predetermined area in the RAM 122. Note that when the image data is expanded into bitmap data by the printer driver on the host side and the bitmap data is transferred to this inkjet recording device, the bitmap image data that is received at the RAM 122 is simply stored.

When dot pattern data corresponding to one line of the print head 113 is obtained, the main control unit 124 sends out this dot pattern data corresponding to one line as serial data to the head driver 136 via the I/F 126, in synchronization with clock signals from an oscillation circuit. The main control unit 124 sends out latch signals to the head driver 136 at predetermined timings.

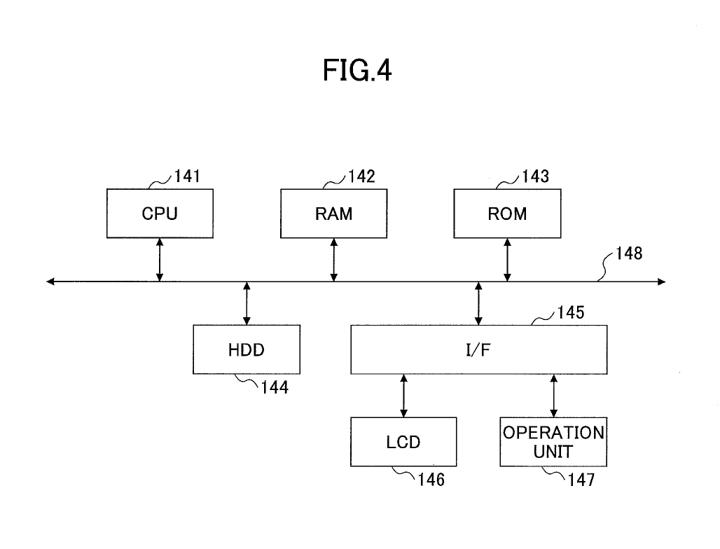

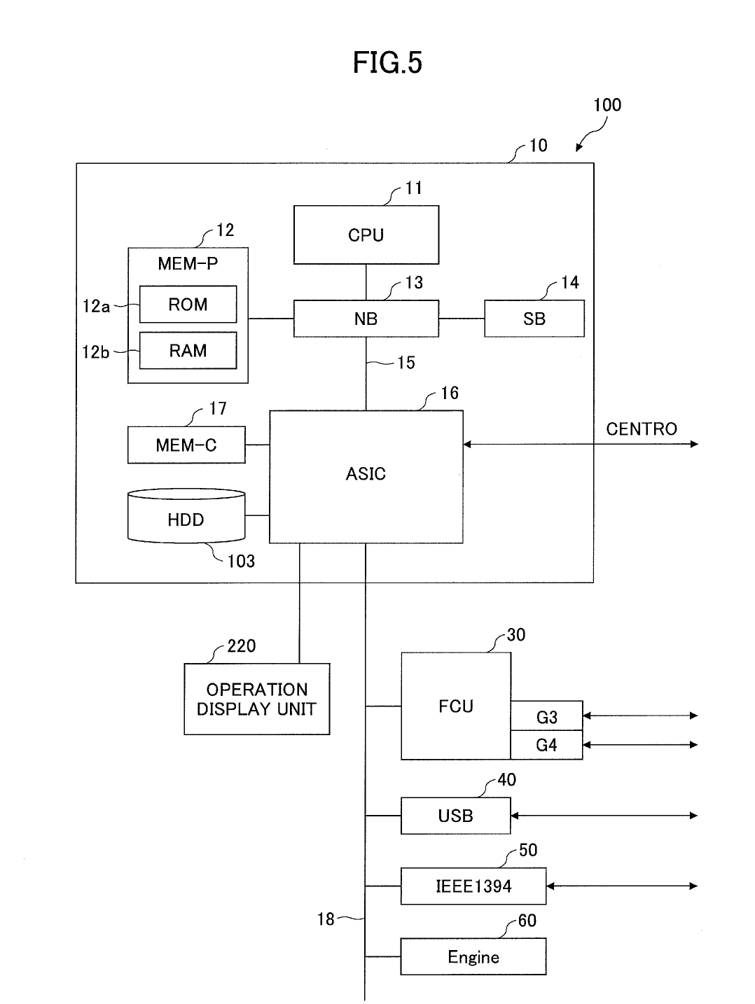

FIG. 4 is an example of a hardware configuration diagram of a PC, a server, and a mobile phone. The PC according to an embodiment has the same configuration as a generally used information processing terminal.

That is, the PC according to an embodiment includes a CPU 141, a RAM 142, a ROM 143, a HDD (Hard Disk Drive) 144, and an I/F 145, which are connected to each other via a bus 148.

Furthermore, to the I/F 145, an LCD (Liquid Crystal Display) 146 and an operation unit 147 are connected.

The CPU 141 is a processing unit, and is a device for controlling operations of the entire PC.

The RAM 142 is a volatile storage medium in which information can be read and written at high speed, and is used as a work area when the CPU 141 processes information.

The ROM 143 is a read-only nonvolatile storage medium, and stores programs such as firmware.

The HDD 144 is a nonvolatile storage medium in which information can be read and written, and stores an OS (Operating System), various control programs, application programs, etc.

The I/F 145 connects the bus 148 with various hardware, a network, etc., and implements control.

The LCD 146 is a visual user interface for the user to confirm the state of the PC.

The operation unit 147 is a user interface for the user to input information in the PC, such as a keyboard and a mouse.

FIG. 5 is an example of a hardware configuration diagram of a printer (MFP).

The MFP (Multifunction Printer) 100 illustrated in FIG. 5 includes a controller unit 10 and an engine unit 60, which are connected by a PCI (Peripheral Component Interface) bus 18.

The controller unit 10 is a device for controlling the entire MFP 100, and controlling drawing, communication, and input from an operation unit.

The engine unit 60 is a printer engine, etc., that can be connected to the PCI bus 18, and examples of the engine unit 60 are a monochrome printer, a single drum color printer, a four drum color printer, a scanner, a fax unit, etc.

Note that the engine unit 60 includes an image processing part such as error diffusion and gamma conversion, in addition to a so-called engine part such as a printer, etc.

The controller unit 10 includes a CPU 11, a north bridge (NB) 13, a system memory (MEM-P) 12, a south bridge (SB) 14, a local memory (MEM-C) 17, an ASIC (Application Specific Integrated Circuit) 16, and a hard disk drive (HDD) 150. The controller unit 10 has a configuration in which the NB 13 and the ASIC 16 are connected by an AGP (Accelerated Graphics Port) bus 15.

Furthermore, the MEM-P 12 includes a ROM 12a and a RAM 12b.

The CPU 11 controls the entire MFP 100, and includes a chip set constituted by the NB 13, the MEM-P 12, and the SB 14. The CPU 11 is connected to other devices via this chip set.

The NB 13 is a bridge for connecting the CPU 11, the MEM-P 12, the SB 14, and the AGP bus 15, and includes a memory controller for controlling reading and writing with respect to the MEM-P 12, a PCI master, and an AGP target.

The MEM-P 12 is a system memory including a memory for storing programs and data, a memory for expanding programs and data, and a memory for drawing by the printer, and includes the ROM 12a and the RAM 12b.

The ROM 12a is a read-only memory used for storing programs and data, and the RAM 12b is a memory in which information can be read and written, which is used as a memory for expanding programs and data and a memory for drawing by the printer.

The SB 14 is a bridge for connecting the NB 13, the PCI device, and peripheral devices. The SB 14 is connected to the NB 13 via the PCI bus 18. To the PCI bus 18, a network interface (I/F) unit, etc., is also connected. The ASIC 16 is an IC (Integrated Circuit) for the purpose of image processing, including hardware elements for image processing.

The ASIC 16 has a role of a bridge for connecting the AGP bus 15, the PCI bus 18, the HDD 150, and the MEM-C 17.

The ASIC 16 includes a PCI target, a AGP master, an arbiter (ARB) that is the core of the ASIC 16, a memory controller for controlling the MEM-C 17, a plurality of DMACs that rotate the image data by a hardware logic, etc., and a PCI unit. The PCI unit performs data transfer with the engine unit 60, via the PCI bus 18. The DMAC is an abbreviation of Direct Memory Access Controller.

To the ASIC 16, a FCU (Facsimile Control Unit) 30, a USB (Universal Serial Bus) 40, and an IEEE 1394 (the Institute of Electrical and Electronics Engineers 1394) interface 50 are connected via the PCI bus 18.

An operation display unit 220 is directly connected to the ASIC 16.

The MEM-C 17 is a local memory used as an image buffer for copying and a code buffer.

The HDD 150 is a storage for storing image data, storing programs, storing font data, and storing forms, and saves license files of applications executed by the MFP 100.

The AGP bus 15 is a bus interface for a graphics accelerator card for increasing the speed of a graphic process. The AGP bus 15 can increase the speed of the graphics accelerator card by directly accessing the MEM-P 12 at high throughput.

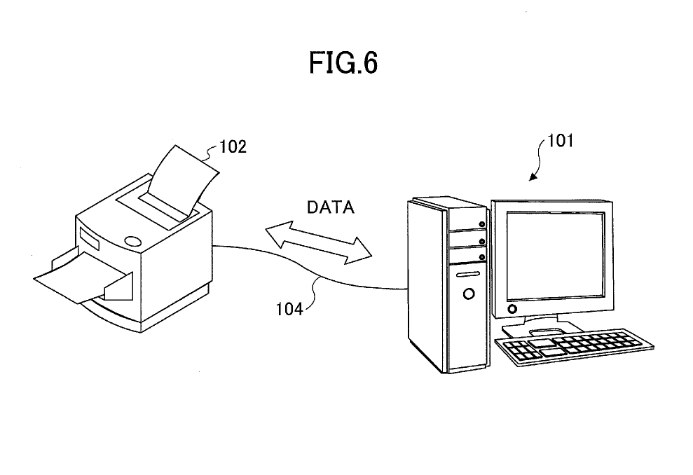

FIG. 6 illustrates a state where the PC and the printer are connected.

A PC 101 and a printer 102 may be connected by the USB cable 104, an IEEE 1394 cable, a network, and other connection means by which communication is possible.

By performing data communication by using a connection means, the PC 101 is able to appropriately recognize the state of the printer 102. For example, when a paper jam of the recording medium 111 occurs on the printer 102 side, the sensor of the printer 102 can detect the paper jam, and send information indicating the location of the paper jam to the PC 101 side. Furthermore, when consumables such as ink and toner have decreased, a sensor (not shown) can detect the remaining amount, and send the information indicating the remaining amount to the PC 101 side to report to the user.

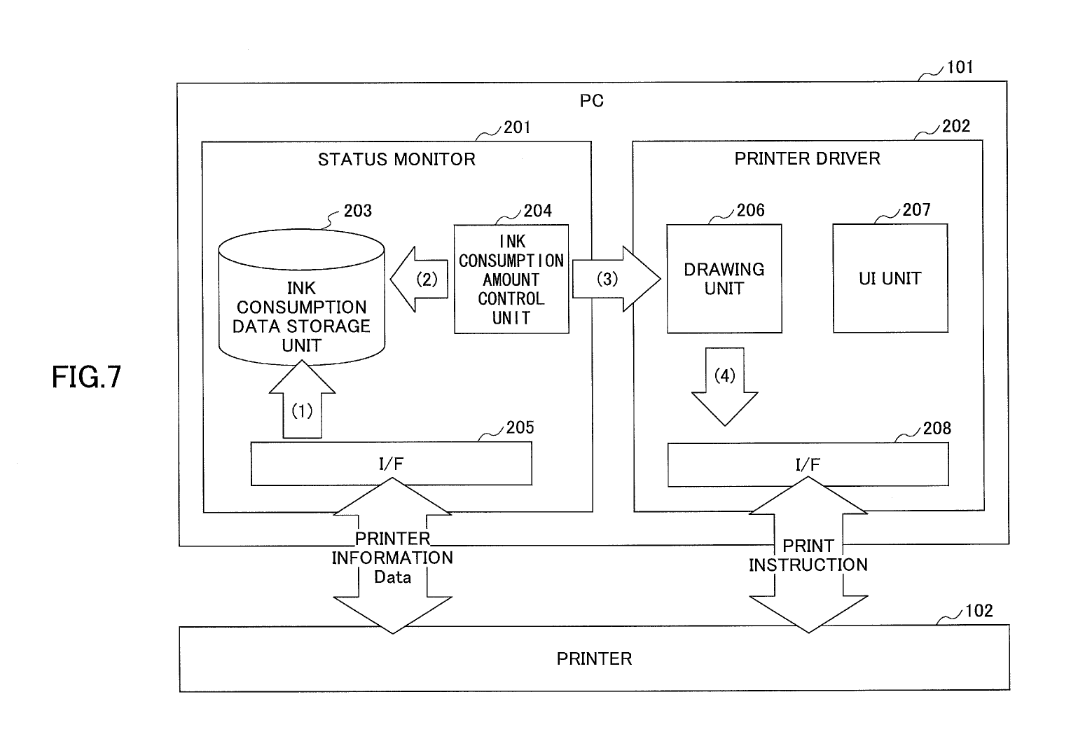

FIG. 7 is an example of a functional block diagram inside the PC.

Inside the PC 101, two software items are installed, i.e., a status monitor 201 and a printer driver 202.

The printer driver 202 includes a UI unit 207 for receiving print setting changes, and a drawing unit 206 for performing image processing when a drawing instruction is received.

The status monitor 201 has a function of receiving printer information (example of status information) of the printer 102 from the printer 102, and displaying the printer information to the user, and storing the information of the PC 101 main unit inside.

That is, the image processing system including the PC illustrated in FIG. 7 is provided with the status monitor 201 and the printer driver 202. The status monitor 201 includes an ink consumption data storage unit 203 for monitoring the usage status of ink by the user and storing the data of usage, and an ink consumption amount control unit 204 for selecting an ink consumption amount reduction measure of a particular color for equalizing the ink consumption amounts of the respective colors based on the stored ink consumption amounts. The printer driver 202 includes a drawing unit 206 for performing image processing when a drawing instruction to the printer 102 is received and sending a print instruction to the printer 102, and a UI unit 207 for receiving a print setting change.

Thick arrow (1): Information of the printer 102 is received from the PC 101 main unit, and the data is stored in the ink consumption data storage unit 203.

Thick arrow (2): The ink consumption amount control unit 204 refers to the data of the ink usage status that is stored. Based on the data stored in the ink consumption data storage unit 203, when it is determined that there is ink of a color that has decreased, and consumption of the decreased ink of the color needs to be suppressed, the consumption amount of this particular ink is adjusted.

Thick arrow (3): An instruction to adjust the consumption amount of the ink is given to the drawing unit 206 of the printer driver 202.

Thick arrow (4): When there is a print instruction, printing is performed in a state where the consumption amount of ink is adjusted according to the instruction of (3), and a print instruction is given to the printer 102.

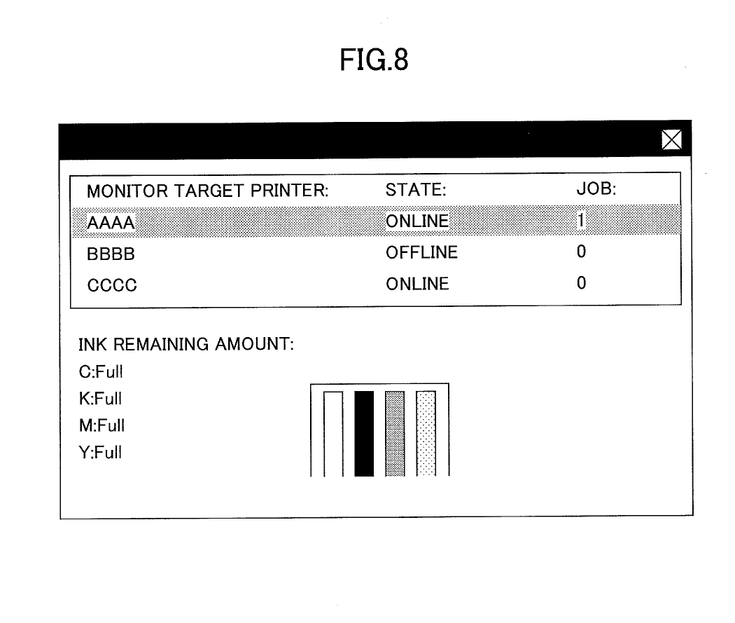

FIG. 8 illustrates an example of a screen UI of the status monitor 201, as an application for monitoring the status of the printer 102 from the PC 101.

It is possible to confirm, from the PC 101, the status of the printer 102 that is connected to the PC 101 by USB or a network.

It is possible to confirm whether the printer 102 is in a usable state, whether the printer 102 is holding a job, the amount of remaining ink, etc.

The PC 101 and the printer 102 can exchange data in a bidirectional manner, and a print instruction and an ink head cleaning instruction are sent from the PC 101 to the printer 102. Conversely, information of the print status to be displayed on the status monitor 201 is sent from the printer 102 to the PC 101.

As the method of monitoring the main unit by the status monitor 201, there is a method of continuously updating the information by being resident, and a method of displaying a pop-up in the screen of the PC 101 when there is some error state in the PC main unit, such as out of paper, the cover is open, out of ink, etc. Furthermore, these methods may be switched according to a setting.

The important point of the present invention is that the data indicating the remaining amount of ink can be received from the printer 102. The application is able to manage the correlative relationship between the passage of time and the consumption of ink, which is an essential element for realizing the present invention.

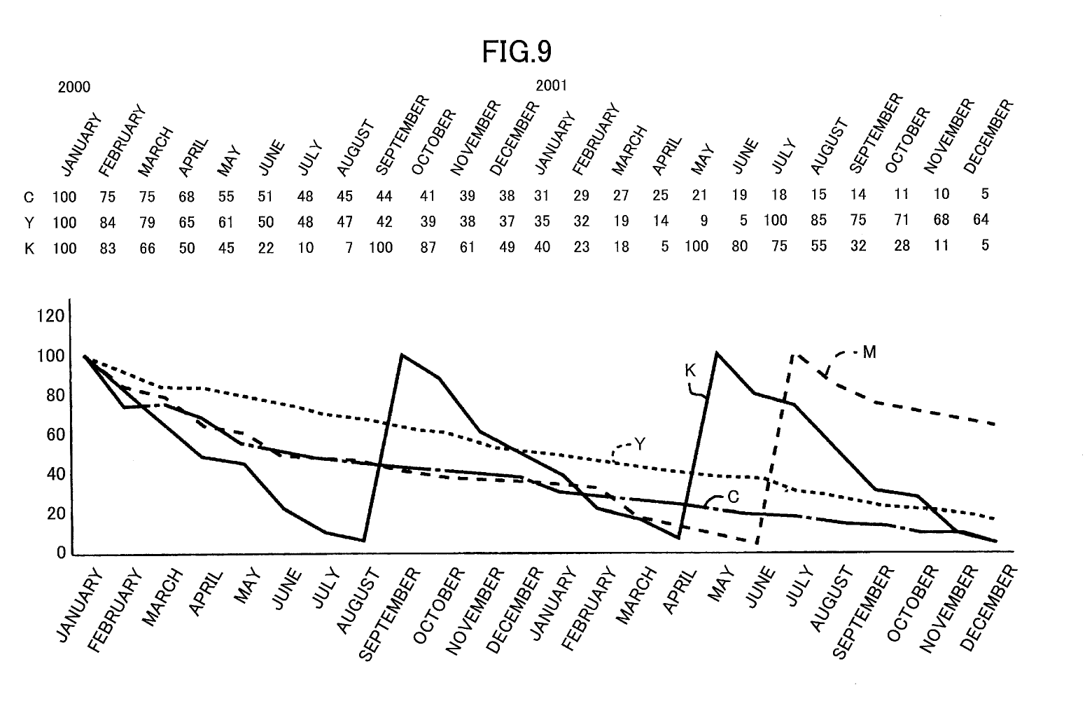

Details are described with reference to FIG. 9.

FIG. 9 illustrates the relationship between the usage period of a certain printer and the consumption amount of ink.

According to the user or the purpose of usage, the consumption amount of ink becomes imbalanced among the respective colors.

A user who mainly prints text is inclined to consume a large amount of ink of K. A user who prints a large amount of images including the blue sky is inclined to consume a large amount of ink C.

In this sample, the ink of K is used most frequently, and the cartridge of K has been replaced twice within two years. In comparison, the consumption amount of other colors is small, and therefore the corresponding cartridges have been replaced once or zero times within two years.

The values are indicated as examples that are easy to understand; in this sample, the relative values of the consumption in two years are as follows.
K: 295
M: 136
Y: 83
C: 95

When expressing black, the printer 102 draws by using a single color K, or a mixture of K+CMY. By using a single color K, it is difficult to express a black color that appears beautiful visually. Therefore, for the purpose of correcting the appearance, the respective colors are added to K; however, if visual beauty does not matter, black can be expressed by using ink of only K, or black can be expressed by reducing the amount of the ink of K and using ink of CMY.

That is, if the print quality does not matter, it is possible to adjust the balance of ink of CMYK constituting gray to black colors. This is because the density of grey is expressed by the density of black.

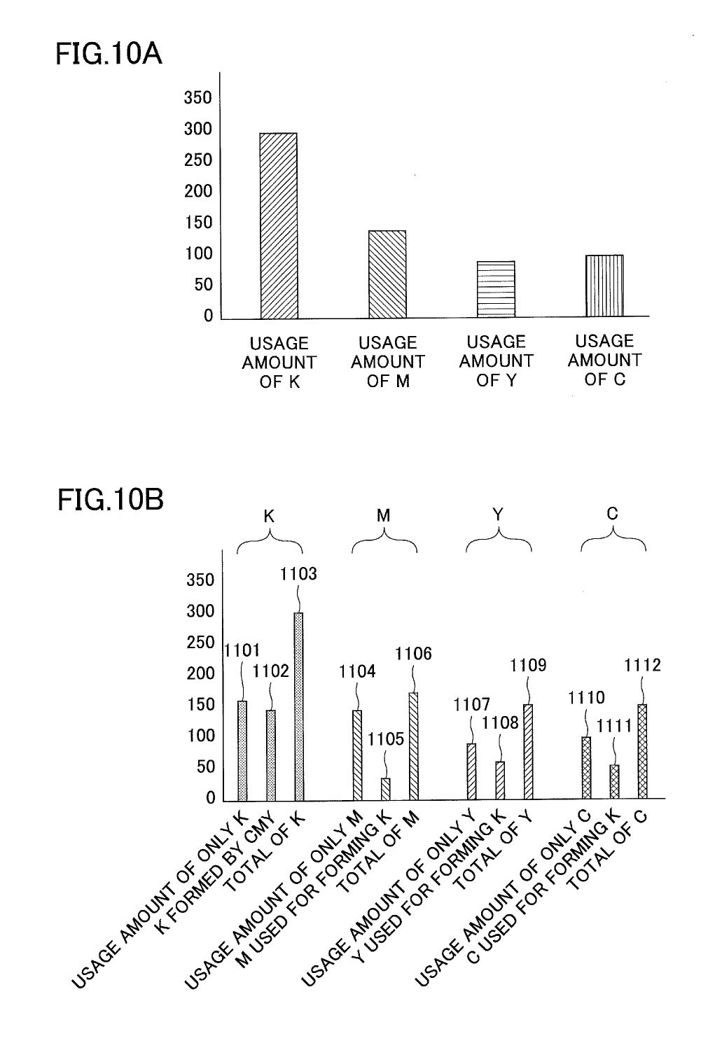

FIG. 10A is a graph of the ink usage amounts within two years; and FIG. 10B is a graph of the ink usage amounts in a case where ink of CMY is used in appropriate ratios as a substitute of the ink of K, for the purpose of reducing the usage amount of the ink of K which is used more than the other ink.

That is, the graph of FIG. 10A indicates the ink usage amounts within two years when the colors are printed by a regular setting. Meanwhile, the graph of FIG. 10B indicates the ink usage amounts within two years in a case where ink of CMY is used for expressing K to perform the same printing as in FIG. 10A. FIG. 10B indicates a case where the respective usage amounts of the ink of CMYK are averaged, by using the ink of CMY instead of K to express black in the printing operation.

The values in the graph of FIG. 10B are as follows.

Usage amount of only K 1101:155

K formed by CMY 1102:140

Total of K 1103:295

Usage amount of only M 1104:136

M used for forming K 1105:30

Total of M 1106:166

Usage amount of only Y 1107:83

Y used for forming K 1108:60

Total of Y 1109:143

Usage amount of only C 1110:95

C used for forming K 1111:50

Total of C 1112:145

That is, “Usage amount of only K” is the actual usage amount of K, and “Total of C”, “Total of M”, and “Total of Y” are the actual usage amounts of CMY.

The bars of the respective colors in the graph of FIG. 10B are averaged with respect to the graph of FIG. 10A, such that approximately the same amounts of ink are used.

Assuming that the results as illustrated in the graph of FIG. 10A are obtained as the ink usage status data within two years, from the third year onward, by prioritizing a method of mixing the CMY by a ratio calculated from the data to express black, it is possible to make the consumption amounts of the respective colors become near equal.

The following is a case of an example where ink of K is most consumed. Assuming that any one of the ink of CMY is significantly consumed more than the others, when the ink consumption amount control unit 204 creates ink of a color to be expressed by mixing the ink of CMY, a print setting and an image setting are made to reduce the consumption of the ink, which is consumed more than others.

A description is given of a case where the contents of the data storing the ink usage status indicates that the ink of C is 50, the ink of Y is 100, and the ink of M is 100, where 100 indicates that the remaining amount of ink is full.

When green is expressed by C+Y, the ink is supposed to be mixed as C:Y=1:1; however, the ink consumption amount control unit 204 expresses green by mixing by the ratio of C:Y=1:2.

In this case, the resultant color becomes close to yellowish green instead of green.

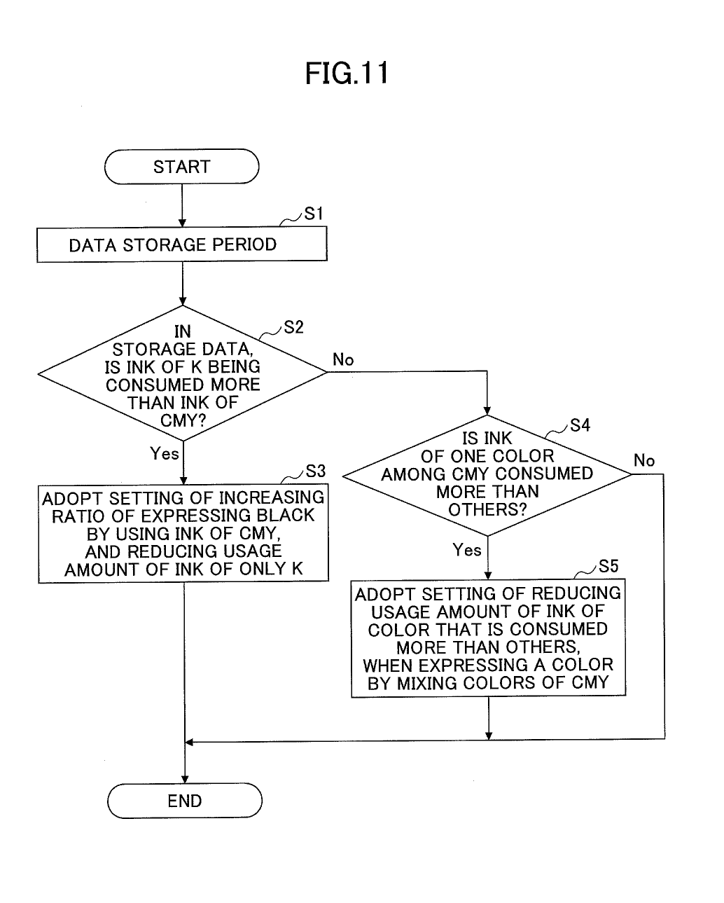

FIG. 11 is an example of a flowchart indicating how to make the setting for reducing the consumption amount with respect to the ink consumption amount data of the printer.

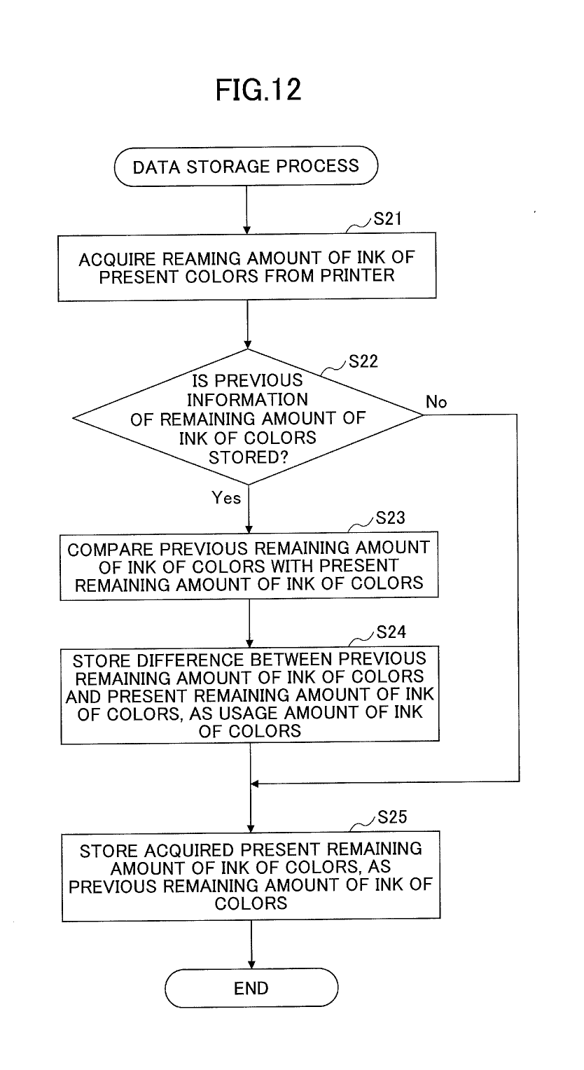

When usage of the printer 102 starts, the status monitor 201 starts storing the data of the ink usage status of the printer 102 (step S1). The process performed during the data storage period of step S1 is described below with reference to FIG. 12.

When a certain amount of ink usage status data is stored, the usage status is confirmed. It is determined whether the ink of K is consumed more than the other colors (step S2). That is, this determination is made by comparing the consumption amounts of ink of the respective colors stored in the ink consumption data storage unit 203.

When it is determined that the ink of K is consumed more than the other colors (YES in step S2), the usage of a mixture of CMY is increased for expressing black, and the ratio of using K only for expressing black is reduced (step S3).

When it is determined that the ink of any one of CMY (not K) is consumed more than others (NO in step S2), it is determined whether any one of the ink of CMY is consumed more than others among CMY (step S4). That is, this determination is made by comparing the consumption amounts of ink of CMY stored in the ink consumption data storage unit 203.

When it is determined that none of the ink of CMY is consumed more than others among CMY (No in step S4), the process is ended, and when it is determined that one of the ink of CMY is consumed more than others among CMY (YES in step S4), the process proceeds to step S5. In step S5, the ratio when the ink of CMY is mixed to express a color is changed, such that the consumption ratio of the ink of the color that is consumed more than others is set to be low.

FIG. 12 is an example of a flowchart of processing procedures performed during the data storage period of step S1 in FIG. 11. The PC 101 may periodically perform the process of FIG. 12 (for example, every month, every day, etc.), or may perform the process of FIG. 12 whenever the user makes an instruction to the PC 101.

First, the PC 101 acquires the present remaining amount of ink of the respective colors from the printer (step S21).

The PC 101 determines whether the previous remaining amount of ink of the respective colors is stored in the ink consumption data storage unit 203 (step S22).

When the determination of step S22 is NO, the process of FIG. 12 is ended.

When the determination of step S22 is YES, the PC 101 compares the previous remaining amount of ink of the respective colors with the present remaining amount of ink of the respective colors (step S23).

Then, the PC 101 stores the difference between the previous remaining amount of ink of the respective colors and the present remaining amount of ink of the respective colors, as the usage amount of ink of the respective colors, in the ink consumption data storage unit 203 (step S24). Note that when the present remaining amount of ink exceeds the previous remaining amount of ink (when the ink has been used up and the ink has been replenished), a value obtained by adding the previous remaining amount of ink to the difference between the maximum amount of ink and the present remaining amount of ink, is set as the usage amount of ink.

The present remaining amount of ink acquired in step S21 is stored as the previous remaining amount of ink of the respective colors, in the ink consumption data storage unit 203 (step S25).

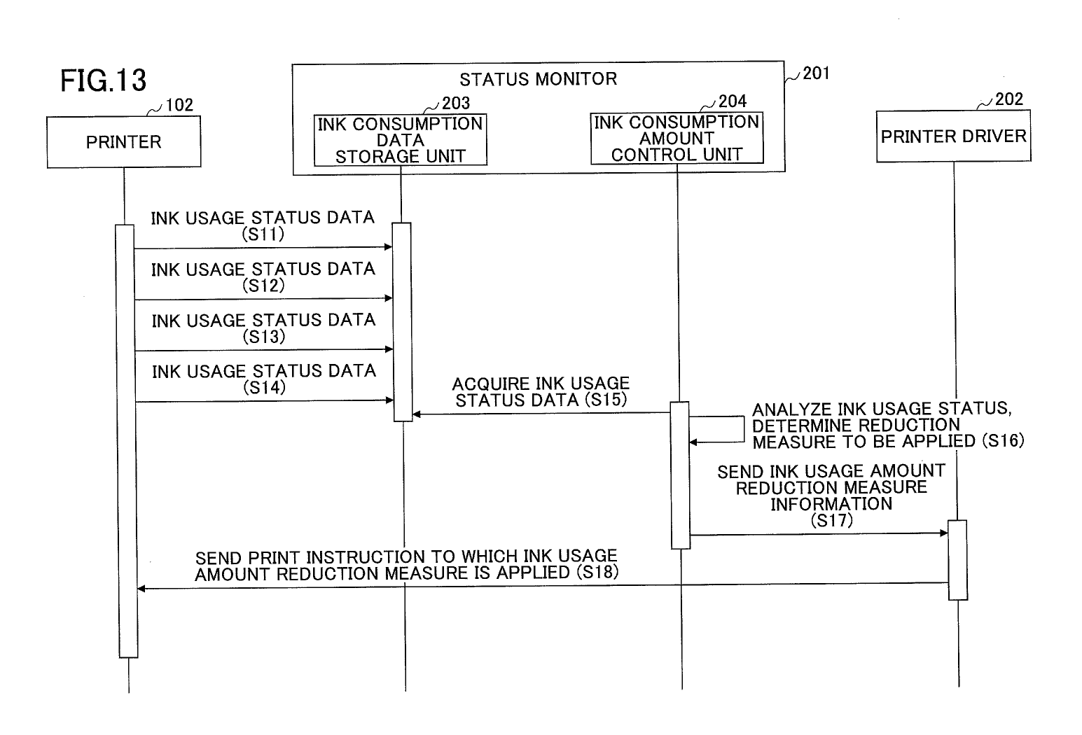

FIG. 13 is an example of a sequence diagram indicating the exchange of data among the printer 102, the status monitor 201, and the printer driver 202.

From the printer 102, according to need, the data of the ink usage amount information is sent to the ink consumption data storage unit 203 of the status monitor 201 (steps S11 through S14), and is stored in the ink consumption data storage unit 203.

When the stored data reaches a certain amount, the ink consumption amount control unit 204 acquires and refers to the ink usage status data (step S15), and determines the ink consumption amount reduction measure to be applied for equalizing the consumption of ink (step S16). Note that detailed processes of step S16 of FIG. 13 are indicated in steps S2 through S5 of FIG. 11.

“The stored data reaches a certain amount” means that data of the respective usage amounts of ink of more than a fixed period is stored in the ink consumption data storage unit 203, or it is confirmed that the ink that is used most or the ink that is used least is used by more than a certain amount, from when storage of the data has started.

Furthermore, other than the method of steps

S15, S16, the ink consumption amount control unit 204 may determine the ink consumption amount reduction measure at every fixed period, or may determine the ink consumption amount reduction measure every time printing is performed.

A description is given of a method of calculating the ink consumption amount reduction measure.
(i) The ink consumption amount reduction measure may be calculated based on the usage amount of ink of the respective colors in a fixed period immediately before the present period, or may be calculated based on the usage amount of ink of the respective colors of all periods for which data has been stored.
(ii) The ink consumption amount reduction measure may be calculated in consideration of whether a period in which printing is performed by using the ink consumption amount reduction measure is included among the periods for which data has been stored.

For example, when printing is performed by using the ink consumption amount reduction measure in the fixed period immediately before the present period, the ink usage amount of the fixed period immediately before the present period is compared with the ink usage amount of a fixed period of the same length before implementing the ink consumption amount reduction measure, and the ink consumption amount reduction measure is determined. There may be cases where the ink is not used as assumed, even when an ink consumption amount reduction measure is determined. For example, in printing where high image quality is requested, the printer 102 may print without applying the ink consumption amount reduction measure. In such a case, it is preferable to consider the ratio of CMY used in the reduction measure, instead of simply making calculations from the usage amount. Accordingly, the following effects can be achieved. For example, when the consumption amount of K was initially large, an ink consumption amount reduction measure 1 for reducing the consumption amount of K has been implemented; however, even in the period during which the ink consumption amount reduction measure 1 was implemented, the consumption amount of K was still large. Thus, by calculating the ink consumption amount reduction measure according to the method (ii), an improvement can be made to obtain an ink consumption amount reduction measure 2 by which the consumption amount of K can be further reduced.

The ink consumption amount control unit 204 sends the information of the ink consumption amount reduction measure to the printer driver 202 (step S17).

In the subsequent printing operations, the printer driver 202 sends, to the printer 102, a print instruction to which the ink consumption amount reduction measure received from the ink consumption amount control unit 204 is applied (step S18).

A “print instruction to which the ink consumption amount reduction measure is applied” means, for example, the following instruction. The printer driver 202 determines the ink consumption amount reduction measure based on data that is the print target for which a print request has been received via a document creating application, an image editing application, etc. This ink consumption amount reduction measure is, for example, to generate print data that the printer can interpret, such that the usage amount of ink of the color, which has been determined to be reduced, becomes small. Then, the printer driver 202 sends the generated print data to the printer 102.

### <Program>

The printer according to an embodiment of the present invention described above is realized by a program that causes a computer to execute a process. Examples of a computer are general-purpose computers such as a personal computer and a work station; however, the present invention is not so limited. A description is given of a case where the functions of the present invention are realized by a program.

For example, there is
a program that causes a computer that constitutes a printer to execute a process,
the printer including
   an ink consumption amount data storage unit configured to store data of a consumption amount of ink, and
   an ink consumption amount control unit and a control unit configured to control the consumption amount of ink, the process including
monitoring an ink usage status of a user and storing the data of the consumption amount of ink of the user, by the ink consumption amount data storage unit;
selecting an ink consumption amount reduction measure for a particular color to equalize the consumption amounts of ink of respective colors based on the stored data of the consumption amount of ink, by the ink consumption amount control unit; and
sending information of the ink consumption amount reduction measure for the particular color to a printer driver, and causing a printer to perform printing by ink proportions for equalizing the consumption amounts of ink of the respective colors in subsequent printing operations, by the control unit.

Furthermore, in addition to the above configuration,
the program causes the computer to execute the processes including
selecting whether to perform printing by applying the ink consumption amount reduction measure for the particular color, or to perform printing by a regular ink consumption rate without applying the ink consumption amount reduction measure, based on the stored data of the consumption amount of ink, by a selecting unit.

Furthermore, in addition to the above configuration,
the program causes the computer to execute the processes including
specifying an accumulated amount of the stored data of the consumption amount of ink at which the ink consumption amount reduction measure is to start being implemented, by a specifying unit.

The above program may be stored in a computer-readable storage medium.

### <Storage Medium>

Here, examples of a storage medium are a computer-readable storage medium such as a CD-ROM, a flexible disk (FD), a CD-R, etc.; a semiconductor memory such a flash memory, a RAM, a ROM, a FeRAM, etc.; and a HDD.

The CD-ROM is an abbreviation of Compact Disc Read Only Memory. The flexible disk is an FD. the CD-R is an abbreviation of CD Recordable.

### <Operation Effects>

As described above, according to the present embodiment, the ink usage status of a user is monitored for a long period of time and the data is stored, and a print setting and an image setting are made, such that the imbalance in color consumption, which is unique to the user, is reduced. As a result, the more the inkjet printer is used, the more the information indicating the colors that the user tends to use, is stored. Therefore, it is possible to reduce circumstances where the ink of a particular color is always continuously consumed more than others. That is, the daily ink usage amounts can be averaged.

Furthermore, according to the present embodiment, in printing operations in which an ink consumption amount reduction measure is applied, there are cases where an imbalance in colors occurs, or a visually beautiful black cannot be expressed. Depending on the data that the user intends to print, it is assumed that there are cases where an imbalance in the color, etc., can be allowed and cases where this cannot be allowed. Therefore, if the user is able to determine whether or not to apply the ink consumption amount reduction measure, it is possible to select which to prioritize between the print quality or the equalization of ink consumption amounts.

Furthermore, according to the present embodiment, the length of the period of usage by which it is possible to identify the tendency in the imbalance of ink usage by the user, varies according to the user. Therefore, if an arbitrary data collection period can be set, it is possible to apply a more effective ink consumption amount reduction measure to subsequent printing operations at a more appropriate timing.

According to one embodiment of the present invention, an image processing apparatus and an image processing method are provided, which are capable of averaging the daily ink usage amounts.

The image processing apparatus and the image processing method are not limited to the specific embodiments described herein, and variations and modifications may be made without departing from the spirit and scope of the present invention.

The printer 102 is an example of an image processing apparatus. The image processing performed by the printer 102 is an example of an image processing method.

The present application is based on and claims the benefit of priority of Japanese Priority Patent Application No. 2014-178571, filed on Sep. 2, 2014, and Japanese Priority Patent Application No. 2015-161139, filed on Aug. 18, 2015, the entire contents of which are hereby incorporated herein by reference.

What is claimed is:

1. A non-transitory computer-readable recording medium storing a program that causes a computer that constitutes an image processing apparatus to execute a process,
the image processing apparatus including
an ink consumption amount data storage unit configured to store data of a consumption amount of ink, and
an ink consumption amount control unit and a control unit configured to control the consumption amount of ink, the process comprising:
monitoring an ink usage status of a user and storing the data of the consumption amount of ink of the user, by the ink consumption amount data storage unit;
selecting an ink consumption amount reduction measure for a particular color to equalize the consumption amounts of ink of respective colors based on the stored data of the consumption amount of ink, by the ink consumption amount control unit; and
sending information of the ink consumption amount reduction measure for the particular color to a printer driver, and causing a printer to perform printing by ink proportions for equalizing the consumption amounts of ink of the respective colors in subsequent printing operations, by the control unit.

2. The non-transitory computer-readable recording medium according to claim 1, wherein the image processing apparatus further includes a selecting unit, the process further comprising:
selecting whether to perform printing by applying the ink consumption amount reduction measure for the particular color, or to perform printing by a regular ink consumption rate without applying the ink consumption amount reduction measure, based on the stored data of the consumption amount of ink, by the selecting unit.

3. The non-transitory computer-readable recording medium according to claim 1, wherein the image processing apparatus further includes a specifying unit, the process further comprising:
specifying an accumulated amount of the stored data of the consumption amount of ink at which the ink consumption amount reduction measure is to start being implemented, by the specifying unit.

4. An image processing apparatus comprising:
a status monitor; and
a printer driver, wherein
the status monitor includes
an ink consumption amount data storage unit configured to monitor an ink usage status of a user and store data of a consumption amount of ink of the user, and
an ink consumption amount control unit configured to select an ink consumption amount reduction measure for a particular color to equalize the consumption amounts of ink of respective colors based on the stored data of the consumption amount of ink, and wherein
the printer driver includes
a drawing unit configured to perform image processing when a drawing instruction to a printer is received, and send a print instruction to the printer, and
a UI unit configured to receive a print setting change.

5. The image processing apparatus according to claim 4, further comprising:
a selecting unit configured to select whether to perform printing by applying the ink consumption amount reduction measure for the particular color, or to perform printing by a regular ink consumption rate without applying the ink consumption amount reduction measure, based on the stored data of the consumption amount of ink.

6. The image processing apparatus according to claim 4, further comprising:
a specifying unit configured to specify an accumulated amount of the stored data of the consumption amount of ink at which the ink consumption amount reduction measure is to start being implemented.

7. An image processing method comprising:
receiving and storing status information including data of an ink usage status of an image processing apparatus;
referring to the stored data of the ink usage status, and adjusting a consumption amount of ink when consumption of ink of a color of a small amount needs to be suppressed;
giving an instruction to adjust the consumption amount of ink to a drawing unit of a printer driver; and
causing a printer to perform printing so that the consumption amount of ink is adjusted, when a print instruction is received.

8. The image processing method according to claim 7, further comprising:
selecting whether to perform printing so that the consumption amount of ink is adjusted, or to perform printing by a regular ink consumption rate without adjusting the consumption amount of ink, based on the stored data of the ink usage status.

9. The image processing method according to claim 7, further comprising:
specifying an accumulated amount of the stored data of the ink usage status at which the consumption amount of ink is to start being adjusted.
